(19) United States
(12) Patent Application Publication
(10) Pub. No.: US 2024/0375491 A1
(43) Pub. Date: Nov. 14, 2024

(54) REAR WINDOW PROTECTION APPARATUS AND METHOD

(71) Applicants: WILLIAM SANSALONE, COLLEGEVILLE, PA (US); EDWARD SANSALONE, PHILADELPHIA, PA (US)

(72) Inventors: WILLIAM SANSALONE, COLLEGEVILLE, PA (US); EDWARD SANSALONE, PHILADELPHIA, PA (US)

(21) Appl. No.: 18/144,420

(22) Filed: May 8, 2023

(51) Int. Cl. B60J 1/20; B32B 3/04; B32B 5/02; B32B 5/18; B32B 5/24; B32B 5/26; B32B 25/10; B32B 25/12

(52) U.S. Cl. CPC B60J 1/2094; B32B 3/04; B32B 5/022; B32B 5/024; B32B 5/18; B32B 5/245; B32B 5/275; B32B 25/10; B32B 25/12; B32B 2262/0276; B32B 2262/062; B32B 2266/06; B32B 2266/08; B32B 2307/73; B32B 2571/00; B32B 2605/00; B60J 1/1807

(57) ABSTRACT

Protective shields for a flexible vehicle rear window mounted in a fabric roof material of a convertible vehicle when the convertible roof is in the “top-down” folded position and where the protective panels have a thickness of approximately 1 inch and generally rectangular shapes such that the panels are slightly greater in perimeter dimensions than the flexible convertible vehicle rear window and when placed on opposite sides of the flexible window provide protection against abrasion and wear and wherein the protective panels are held in place by compressive force of the folded convertible roof.

The present invention relates to the field of automobile window protectors and more specifically, to protectors for both flexible and rigid rear windows used in convertible automobile tops and to apparatuses and methods for protecting such windows from damage and degradation.

### BACKGROUND OF THE INVENTION

Convertible vehicles have been a feature of automotive history since the advent of the horseless carriage. A convertible or cabriolet is a passenger vehicle that can be driven with or without a roof in place. For so-called “soft top” convertibles, a selectively foldable, collapsible rigid frame provides a structure over which single or multi-ply fabric materials such as cotton canvases, oil cloths as well as synthetic fabrics and combinations thereof are attached to provide a semi-permanent barrier to the elements when the top is in the fixed or closed position. As used herein, roof material is understood to encompass any flexible, foldable fabric and non-fabric materials, including combinations thereof suitable for fabricating a convertible top. A convertible top is understood to be one made of roof material that may be retracted, folded down and internally stored in the trunk or boot of the vehicle, to allow an open-air driving experience when desired, with the ability to provide a roof and protection from the elements when required.

When a roof is required, it will be appreciated that there is a need for the top to include a rear window to allow light to enter the vehicle and to permit the driver to use a rear-view mirror to observe traffic and other driving conditions in order to safely operate the vehicle. For soft top convertibles the choice of rear window materials are typically limited to shatterproof glass which can increase the weight of the top, or a flexible lightweight clear plastic material. Rear windows which are made of plastic, must have good visual characteristics to ensure a clear and undistorted view. Not only must they be sufficiently flexible so that they can go along in the folding operation of the top when the top is in the retracted or open position without suffering any buckling or permanent deformation, but they must also be lightweight but sufficiently rigid so that, when the top is closed, they assume a shape that has no waves which would distort the visual information received by a driver.

The flexible windows made of plastic (such as plasticized PVC) which have historically been used in convertibles generally meet the requirements with respect to desirable visual characteristics, weight, and elasticity. However, a disadvantage of these flexible windows is that they are extremely susceptible to scratching. Indeed, according to the operating instructions of certain vehicle manufacturers, convertibles with flexible windows must be not driven through automatic car wash installations because the brushes of the car wash installations will scratch the windows. Additionally, all vehicles, but especially convertibles when the roof is retracted, are subject to increased transmission of vibration energy caused by driving on bumpy roads and by vehicle acceleration and deceleration. Moreover, because convertible vehicles lack the same rigid type of structure found in non-convertible vehicles, when the top is retracted, the increased vibration energy transmission allows the collapsible rigid frame structure of the folded top to flex and bounce. It will be appreciated that when the top is down and internally stored in the vehicle trunk, this provides conditions that can allow the flexible window to repeatedly rub against the fabric of the roof material damaging the window via friction. Finally, the combined effects of rubbing friction between the window and the roof material when the top is down and repeated exposure to the elements, particularly sunlight, when the top is up causes increased wear and degradation of the flexible plastic window material. Over time, long before the top or the frame needs repair, a replacement or exchange of the flexible window will be necessary resulting in repair shop time and relatively high costs.

Previous attempts at addressing the reduction of friction on the window include unsatisfactory and unreliable makeshift solutions such as a fabric or folded bath towel that can be placed between the fabric top and the window during top retraction. However, in use, fabrics tend to shift and to not stay in place. Also, on occasion, the fabric will bunch-up which can actually cause significant permanent deformation of the window to a degree that interferes with the visual information received by the driver when the top is placed in the up or closed orientation.

Patent application publication US 2015/0047797 A1 to Weyer is yet another example of an attempt to address the reduction of friction on windows in convertible vehicles by a protective shield. Weyer comprises a rigid or semi-rigid transparent or translucent acrylic or polycarbonate protective sheet and magnetic attachment mechanisms, such as button magnets, which are secured within the sheet. The magnets are used to attach the protective sheet to the exterior of the convertible top at or near the rear window opening.

It will be appreciated that the magnets used with the Weyer sheet must be sufficiently sized to ensure satisfactory attraction to the metal frame of the vehicle soft-top. The location of the magnets may also interfere with the proper folding of the metal frame. When in the top-down or closed position, these magnets can also be attracted to adjacent frame parts which would allow the protective sheet to become dislodged. Additionally, Weyer contemplates protecting only one surface of the window to be covered, leaving the other surface of the window essentially unprotected. Lastly, the friction caused by vehicle operation and vibration, and after repeated use, the magnets could have the tendency to rub and wear against the protective sheet, eventually becoming loosened and separated from the protective sheet. Weyer is, at best, a temporary solution that provides minimal protection of only one window surface.

It will be appreciated that there remains a need for a convenient, low-cost and easily stored device that can protect both the window inner and outer surfaces from frictional wear and degradation.

### SUMMARY OF THE INVENTION

The present invention comprises selectively placeable, lightweight, easily storable, protective shields that protect the inner and outer surfaces of a flexible rear vehicle window of a convertible vehicle yet do not impede the operation of the vehicle in which the window is incorporated and does not mar or physically alter the window or the vehicle in which the window is incorporated.

In one or more embodiments, the protective shields of the present invention comprise a pair of generally rectangular lightweight flexible panel-like members which may be covered in a soft compatible fabric material. The panels are dimensioned to approximate the size of the vehicle window for which protection is sought and are shaped to extend at least partially beyond the window's perimeter dimensions. The panel-like members are generally less than 2 inches in thickness and more preferably, are between ⅛ and ¾ inches thick. Thinner panels, depending on panel materials are also contemplated but it will be appreciated that increased panel thickness provides greater protection and other advantages, although any desired thickness can be used. Preferred panel materials include cotton batting, natural rubber mats and foams, such as open and closed cell foams, combinations of these materials as well as other similar lightweight and durable materials.

In one embodiment, a second protective panel is placed into position in the trunk portion of the convertible vehicle. The placement of the second panel will correspond to the location of the rear window of the convertible top when the top is in the open or top-down position and provides a protective cushion upon which the rear window outer surface rests. After the vehicle top has been retracted, a first protective panel is placed above the inner surface of the vehicle rear window. In some instances, placement of the first panel can also be accomplished during a pause in the roof retraction process; however, in either case it will be appreciated that the vehicle rear window is essentially gently sandwiched between the first and second protective panels which are held in place by compressional weight of a convertible top. It will be further understood that convertible tops are defined as those comprising a roof material of flexible, foldable fabric and non-fabric materials, including combinations thereof suitable for fabricating a temporary impermeable barrier to the elements.

In other embodiments, the specific folding mechanism of the convertible top differ from the above and may in essence, reverse the orientation of the inner and outer surfaces of the window such that the inner surface of the window rests on the first protective panel and the second protective panel is placed above the outer surface of the vehicle rear window. In such instances, it will be understood that the protective panels will likewise be situated on either side of a flexible rear window and held in pace by compressional forces.

### BRIEF DESCRIPTION OF THE DRAWINGS

The invention is best understood from the following detailed description when read in conjunction with the accompanying drawings wherein like reference numerals refer to like parts throughout the several views and embodiments. It is emphasized that, according to common practice, the various features of the drawings are not to-scale. On the contrary, the dimensions of the various features are arbitrarily expanded or reduced for clarity. Included in the drawings are the following figures:

FIG. 1 is a plan view drawing of one embodiment of a first protective panel of the present invention.

FIG. 2 is cross-sectional view drawing of the first protective panel of FIG. 1 along the line 2-2.

FIG. 3. is a plan view drawing of one embodiment of a second protective panel of the present invention.

FIG. 4 is cross-sectional drawing the second protective panel of FIG. 3 along the line 4-4.

FIG. 5 is cross-sectional drawing of one embodiment of the protective panels of the invention positioned within a convertible top during retraction.

FIG. 6 is cross-sectional drawing of an alternate embodiment of the invention positioned within a convertible top during retraction.

FIG. 7 is cross-sectional drawing of the embodiment of the protective panels of the invention as shown in FIG. 5 positioned within a convertible top after retraction.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion.

These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to exemplified embodiments and examples. However, it will be apparent to those of ordinary skill in the art that the invention may be practiced without these specific details. In other instances, well-known features have not been described in detail so as not to obscure the invention. Accordingly, the invention expressly should not be limited to such exemplified embodiments illustrating some possible but non-limiting combination of features that may be provided alone or in other combinations of features; the scope of the invention being defined by the claims appended hereto.

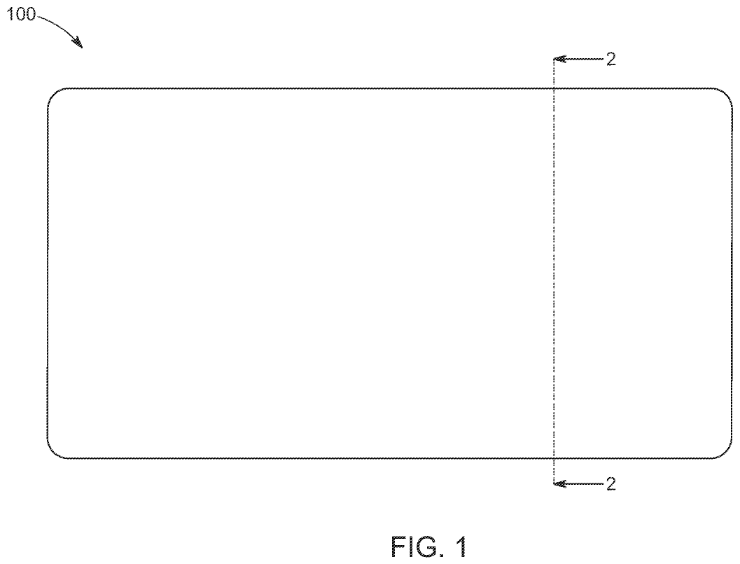

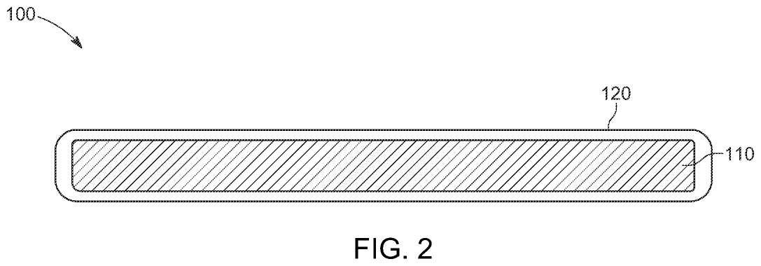

FIG. 1 is a plan view drawing of one embodiment of a first protective panel of the present invention. FIG. 2 is cross sectional view of the embodiment shown in FIG. 1 along the line 2-2. From FIGS. 1 and 2, it will be appreciated that first protective panel 100 comprises a generally rectangular lightweight flexible member 110 which preferably may be covered in a soft compatible fabric material 120. The panels are dimensioned to approximate the size of the vehicle window for which protection is sought and are shaped to extend at least partially beyond the window's perimeter dimensions. In one embodiment, first protective panel 100 is approximately 41″ in length and 15″ in width and is generally less than 2 inches in thickness and more preferably, are between ⅛″ and ¾″ thick.

In the embodiments of FIGS. 1 and 2, first protective panel 100 is more preferably between ⅛″ to ½″ in thickness and has a generally rectangular shape with rounded corners. However, it will be appreciated that first protective panel 100 can have any shape, and any desired thickness which may be dependent on the dimensions of the rear window opening in the convertible roof as discussed in greater detail below. Thinner panels, depending on panel materials are also contemplated but it will be appreciated that increased panel thickness provides greater protection and other advantages, although any desired thickness can be used. Preferred flexible member 110 materials include cotton batting, natural rubber mats and foams, such as open and closed cell foams, and combinations of these materials as well as other similar lightweight and durable materials. Closed cell foams and natural rubber mats are also preferred in many instances because they resist water absorption and resultant mildew formation which can occur in a vehicle trunk environment due to constantly changing temperature and levels of humidity.

In forming first protective panel 100, flexible member 110 is preferably covered in a lightweight soft fabric material 120. Fabric material 120 it fitted to completely cover flexible member 110 and can be detachably secured to flexible member 110 by any number of known conventional methods and devices including sewn-in seams, hook and loop fasteners, buttons, zippers and other closure means. Preferred closure means will be those that do not present a risk of marring or scratching the flexible rear window surface that first protective panel 100 is intended to protect. Preferably still, fabric material 120 may be removable and washable so as to avoid the accumulation of dust, dirt and other road wear debris which would typically be encountered when the top is in the closed position. Suitable fabric materials include woven and non-woven fabrics, such as pile or napped fabrics, cotton fabrics, polyester fabrics and combinations of the foregoing. Most “synthetic” fibers like polyethylene, polypropylene, polyester have hydrophobic properties and therefore absorb less moisture but can still provide a desired level of softness and durability. Preferred synthetic/synthetic combination fabric materials include members of the velour, terry, and other napped fabrics.

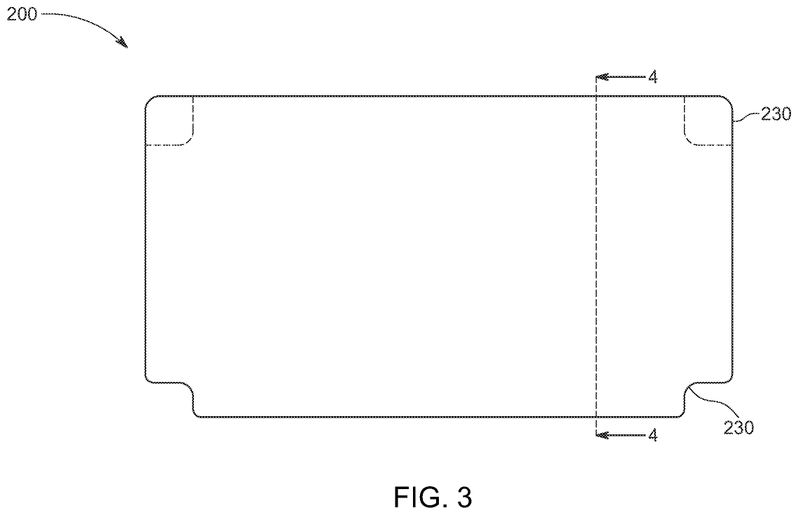

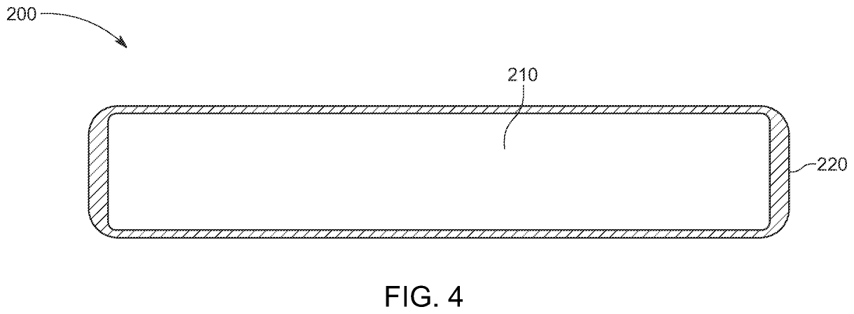

Much like the embodiments of FIGS. 1 and 2, the embodiments shown in FIGS. 3 and 4 show one embodiment of a second protective panel 200. FIG. 4 is cross sectional view of the embodiment shown in FIG. 3 along the line 4-4. From FIGS. 3 and 4, it will likewise be appreciated that second protective panel 200 also comprises a generally rectangular lightweight flexible member 210 which may be covered in a soft compatible fabric material 220. In one embodiment, second protective panel 200 is approximately 39″ in length and 10″ in width and is generally less than 2 inches in thickness and more preferably, are between ⅛″ and ¾″ thick. In still other embodiments, second protective panel 200 is dimensioned to approximate the size of the vehicle window for which protection is sought and are shaped to extend at least partially beyond the window's perimeter dimensions. The panel-like members are generally less than 2 inches in thickness and more preferably, are between ⅛″ and ¾″ thick with a generally rectangular shape and optional corner cut-outs 230. It will be appreciated that optional cut-outs 230 may be present in some or all corners depending on the

Optional corner cut-outs 230 are provided to accommodate roof frame dimension variations for optimal placement and fitment of second protective panel 200 within the window opening space. However, it will also be appreciated that second protective panel 200 can have any shape, and any desired thickness which may be dependent on the dimensions of the rear window opening in the convertible roof as discussed in detail below. Thinner panels, depending on panel materials are also contemplated but it will be understood that increased panel thickness provides greater protection and other advantages, although any desired thickness can be used so long as it provides sufficient surface contact to enable protection. Preferred flexible member materials include cotton batting, natural rubber mats and foams, such as open and closed cell foams, and combinations of these materials as well as other similar lightweight and durable materials. Closed cell foams and natural rubber mats are preferred in many instances because they resist water absorption and resultant mildew formation which can occur in a vehicle trunk environment due to constantly changing temperature and levels of humidity.

In forming second protective panel 200, it will be understood that flexible member 210 is also preferably covered in a lightweight soft fabric material 220. Fabric material 220 is fitted to completely cover flexible member 210 and can be detachably secured to flexible member 210 by any number of known conventional methods and devices including sewn-in seams, hook and loop fasteners, buttons, zippers and other closure means. Preferred closure means will be those that do not present a risk of marring or scratching the flexible rear window surface that second protective panel 200 is intended to protect. Preferably still, fabric material 220 may be removable and washable so as to avoid the accumulation of dust, dirt and other road wear debris which would typically be encountered when the top is in the closed position. Suitable fabric materials include woven and non-woven fabrics, such as pile or napped fabrics, cotton fabrics, polyester fabrics, and combinations of the foregoing. Most “synthetic” fibers like polyethylene, polypropylene, polyester have hydrophobic properties and therefore absorb less moisture but can still provide a desired level of softness and durability. Preferred synthetic/synthetic combination fabric materials include members of the velour, terry, and other napped fabrics families.

With respect to FIGS. 1, 2, 3 and 4, it will be appreciated that the identification of the first protective panel 100 and the second protective panel 200 are relativistic. The two panels may in some instances be virtually identical and/or interchangeable such that second protective panel 200 may be used in place of first protective panel 100 and vice versa.

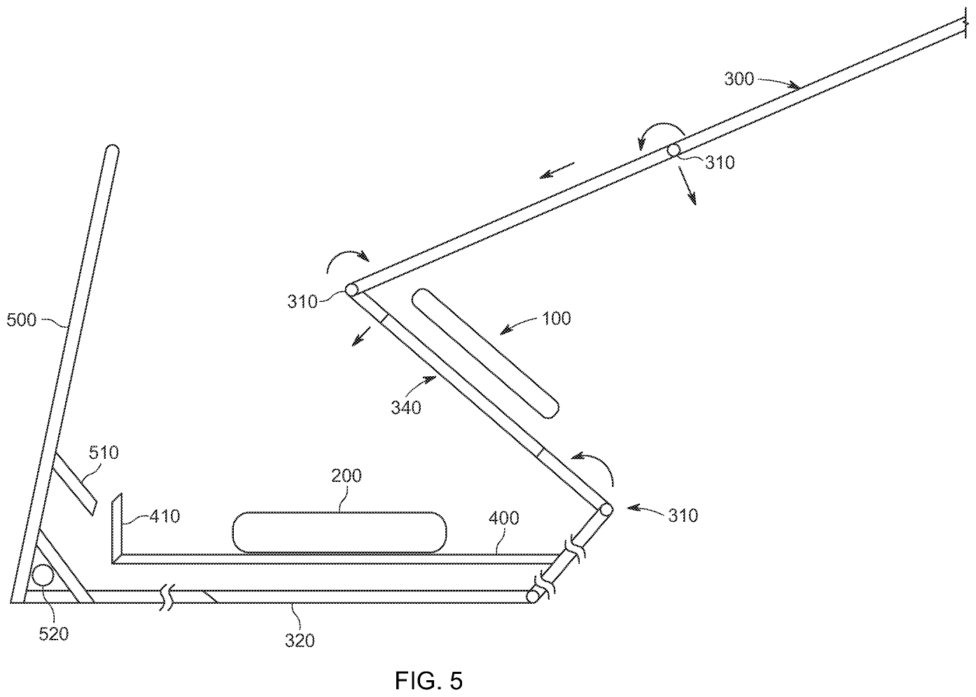

FIG. 5 is a partial cross-sectional view of an embodiment of the first protective panel 100 and second protective panel 200 of the present invention shown in place during closure of one type of a convertible top. It will be understood that the depiction of the frame and the frame components are not necessarily to scale and representative of the general structure of certain types of convertible tops, and that at convertible tops, per se, form no part of the present invention except to the extent that the protective panels are useful therein. It will be further understood that in the depiction shown there is a complimentary essentially mirror-image structure on the opposite side of the vehicle so as to provide a uniform convertible roof support structure.

As can be seen if FIG. 5, roof frame structure 300 comprises roof material 301, a plurality of room frame members 305, intraoperatively connected to roof frame hinges 310 and vehicle attachment members 320. Positioned within roof material 301 supported by roof frame members 305 is rear window area 330 which includes rear window 340. Rear window 340 is preferably a lightweight, clear flexible plastic sheet, formed of polymeric materials of the polyester family such as polyethylene (PE), polypropylene (PP) and polyvinyl chloride (PVC), polyethylene terephthalate (PET), alone or in combination one another and/or with glass fibers which is secured to roof material 301 within rear window opening 330. The present invention may also be useful where rear window 340 is comprised of glass and extra protection and cushioning is desired. Roof material 301 and frame structure 300 is designed and assembled to fold within the trunk or boot of the convertible vehicle generally defined by trunk floor 400, trunk rear wall 410 trunk hood 500, trunk hood wall 510 and trunk hinge 520.

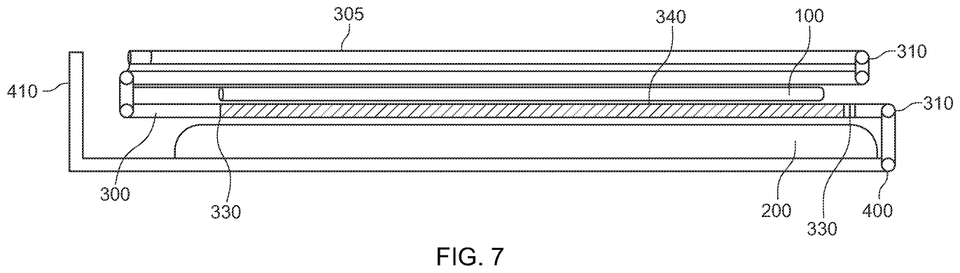

FIG. 5 shows the placement of second protective panel 200, positioned on trunk floor 400. Ideally, second protective panel 200 may be permanently positioned in place on trunk floor 400 to provide protection and cushioning for the outer surface of rear window 340 when is it desired to have the convertible roof in top-down position. As second protective panel 200 is generally thin and planar, it will be relatively unobtrusive taking up minimal truck space. Should additional space be required, it will likewise be appreciated that second protective panel 200, being flexible in composition can be folded or rolled for storage elsewhere in the vehicle trunk or cabin compartment. Positioned opposite first protective panel 200 is first protective panel 100. First protective panel 100 is preferably positioned in place during closure of the roof structure (i.e. from open, roof-up position to closed, roof down position). This may conveniently be accomplished during a pause in the closure operation, or it may be inserted after the roof is completely down prior to the closure of the trunk. First roof panel 100 is positioned on the inner surface side of rear window 340 within the area defined by rear window area 330. As the roof closure completes, first protective panel 100 and second protective panel 200 work in concert to provide protection against abrasion caused by vehicle resonance vibration as well as against dirt, dust and other foreign material that may be on the convertible roof fabric materials or within the vehicle trunk as is shown more clearly in FIG. 7.

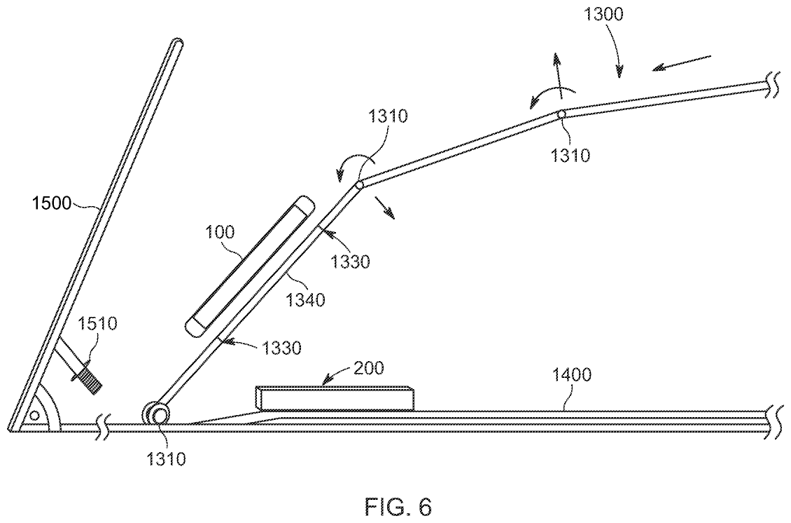

FIG. 6 is also a partial cross-sectional view of an embodiment of the first protective panel 100 and second protective panel 200 of the present invention shown in place during closure of another type of a convertible top. As in the case of the depiction in FIG. 5, it will be understood that the depiction of the frame and the frame components are not necessarily to scale and representative of the general structure of certain types of convertible tops, and that at convertible tops, per se, form no part of the present invention except to the extent that the protective panels are useful therein. It will be further understood that in the depiction shown there is a complimentary essentially mirror-image structure on the opposite side of the vehicle so as to provide a uniform convertible roof support structure.

As can be seen if FIG. 6, roof frame structure 1300 comprises roof material 1301, a plurality of room frame members 1305, intraoperatively connected to roof frame hinges 1310 and to vehicle attachment members 1320. Positioned within roof material 301 at roof frame members 1305 is rear window area 1330 which includes rear window 1340 integrally affixed to roof material 1301. Rear window 1340 is preferably a lightweight, clear flexible plastic sheet, formed of polymeric materials of the polyester family such as polyethylene (PE), polypropylene (PP) and polyvinyl chloride (PVC), polyethylene terephthalate (PET), alone or in combination one another and/or with glass fibers which is secured within rear window opening 1330. The present invention may also be useful where rear window 1340 is comprised of glass and extra protection and cushioning is desired. Roof frame structure 1300 with roof material 1301, is positioned to fold within the trunk or boot of the convertible vehicle generally defined by trunk floor 1400, trunk rear wall 1410 trunk hood 1500, trunk hood wall 1510 and trunk hinge 1520.

FIG. 6 shows the placement of second protective panel 200, positioned on trunk floor 1400. Ideally, second protective panel 200 may be more or less semi-permanently positioned in place to provide protection and cushioning for the inner surface of rear window 1340 when it is desired to have the convertible roof in top-down position. As second protective panel 200 is relatively thin, it will be unobtrusive taking up minimal trunk space. Should additional space be required, it will likewise be appreciated that second protective panel 200, being flexible in composition can be folded or rolled for storage elsewhere in the vehicle trunk or cabin compartment. Positioned opposite first protective panel 200 is first protective panel 100. First protective panel 100 is preferably positioned in place during closure of the roof structure (i.e. from open, roof-up position to closed, roof down position). This may conveniently be accomplished during a pause in the closure operation, or it may be inserted after the roof is completely down prior to the closure of the trunk. First roof panel 100 is positioned on the outer surface side of rear window 340 within the area defined by rear window area 330. As the roof closure completes, first protective panel 100 and second protective panel 200 work in concert to provide protection against abrasion caused by vehicle resonance vibration as well as against dirt, dust and other foreign material that may be on the convertible roof fabric materials or within the vehicle trunk as is exemplified by FIG. 7.

FIG. 7 is a partial cross-sectional drawing showing the embodiment of the convertible roof structure depicted in FIG. 5 in a top-down, folded configuration with second protective panel 200 and first protective panel 100 in place, positioned within roof material 301 at roof frame structure 300. Second protective panel 200 rests on trunk floor 400 and is positioned to be beneath rear window 340, generally defined by roof rear window area 330 within roof material 301. Positioned on the opposite surface of rear window 340 is first protective panel 100, also positioned in the area generally defined by the opposite surface of roof rear window area 330. It will be appreciated that the folded configuration of roof frame structure 300 and roof material 301 are designed to be stored temporarily in the trunk or boot area of the convertible vehicle, typically defined by trunk rear wall 410, in which the convertible roof is deployed. A plurality of roof frame hinges 310 provide the necessary interoperability of the connections which permit efficient and reliable folding of roof frame structure 300, although it will be understood that the embodiment depicted in FIG. 7 is just one of many possible iterations of how a convertible roof may be folded.

With respect to FIGS. 6 and 7, while in some embodiments the protective panels may be put in place during the “top-down opening” procedure, the present invention also contemplates the use of quick-release and other releasable means for securing the panels in place prior to activating the “top-down opening” procedure. Such temporary detachable securing means which are typically placed at or near the perimeter of the protective panels can include but are not limited to hook and loop tabs, fabric button snaps, fabric enclosed magnets all of which can be mated to complementary reciprocal elements already placed or present in the roof cover surface as well inert static sprays and quick release spray adhesives.

While the foregoing description and drawings represent the exemplary embodiments of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What I claim is:

1. A plurality of protective shields for a convertible vehicle rear window mounted in a roof material when in a folded roof position comprising:
a first protective panel having generally rectangular shape with a first panel length dimension and a first panel width dimension that is less than said first panel length dimension, such that said first protective panel is slightly greater in perimeter dimensions than said convertible vehicle rear window when placed over said window, said first protective panel further having a first protective panel thickness; and
a second protective panel having generally rectangular shape with a second panel length dimension and a second panel width dimension that is less than said second panel length dimension, such that said second protective panel is slightly greater in perimeter dimensions than said convertible vehicle rear window when said second protective panel is placed under said window, said second protective panel having a second protective panel thickness slightly greater than said first protective panel thickness,
and wherein the first protective panel and second protective panel are held in place by compressive force of the folded convertible roof.

2. The first protective panel of Claim 1 wherein the lightweight flexible member is selected from the group consisting of cotton batting, natural rubber mats, open and closed cell foams, and combinations thereof.

3. The first protective panel of claim 2 further comprising a cover of fabric materials selected from the group consisting of piled or napped woven fabrics, non-woven fabrics, cotton fabrics, polyester fabrics and combinations of thereof.

4. The first protective panel of claim 1 further comprising a lightweight flexible member comprised of a closed cell foam and a cover of napped fabric material.

5. The first protective panel of claim 4 wherein the napped fabric material is substantially hydrophobic.

6. The second protective panel of claim 1 wherein the lightweight flexible member selected from the group consisting of cotton batting, natural rubber mats, open and closed cell foams, and combinations thereof.

7. The second protective panel of claim 6 further comprising a cover of fabric materials selected from the group consisting of piled or napped woven fabrics, non-woven fabrics, cotton fabrics, polyester fabrics and combinations thereof.

8. The second protective panel of claim 1 further comprising a lightweight flexible member comprised of a closed cell foam and a cover of napped fabric material.

9. The second protective panel of claim 8 wherein the napped fabric material is substantially hydrophobic.

10. The first and second protective panels of Claim 1 wherein the first protective panel is lightweight flexible member comprised of a closed cell foam and a cover of napped substantially hydrophobic fabric material; and wherein the second protective panel is lightweight flexible member comprised of a closed cell foam and a cover of napped substantially hydrophobic fabric material.

11. A kit for providing protection for a flexible rear window mounted in the roof material of convertible vehicle when the roof is in a folded roof position comprising:
a first protective panel having generally rectangular shape with a first panel length dimension and a first panel width dimension that is less than said first panel length dimension, such that said first protective panel is slightly greater in perimeter dimensions than said convertible vehicle flexible rear window when placed over said window, said first protective panel further having a first protective panel thickness; and
a second protective panel having generally rectangular shape with a second panel length dimension and a second panel width dimension that is less than said second panel length dimension, such that said second protective panel is slightly greater in perimeter dimensions than said convertible vehicle flexible rear window when said second protective panel is placed under said window, said second protective panel having a second protective panel thickness slightly greater than said first protective panel thickness,
and wherein the first protective panel and second protective panel are positioned on either side of the flexible rear window and are held in place by compressive force of the folded convertible roof.

12. The kit of claim 11 wherein the first protective panel comprises a lightweight flexible member selected from the group consisting of cotton batting, natural rubber mats, open and closed cell foams, and combinations thereof.

13. The kit of claim 12 wherein the first protective panel further comprises a cover of fabric materials selected from the group consisting of piled or napped woven fabrics, non-woven fabrics, cotton fabrics, polyester fabrics and combinations of thereof.

14. The kit of claim 11 further comprising a lightweight flexible member comprised of a closed cell foam and a cover of napped fabric material.

15. The kit of claim 14 wherein the napped fabric material is substantially hydrophobic.

16. The kit of claim 11 wherein the second protective panel is a lightweight flexible member selected from the group consisting of cotton batting, natural rubber mats, open and closed cell foams, and combinations thereof.

17. The kit of claim 16 wherein the second protective panel comprises a cover of fabric materials selected from the group consisting of piled or napped woven fabrics, non-woven fabrics, cotton fabrics, polyester fabrics and combinations thereof.

18. The kit of claim 11 wherein the lightweight flexible member is comprised of a closed cell foam and the cover is comprised of napped fabric material.

19. The second protective panel of claim 18 wherein the napped fabric material is substantially hydrophobic.

20. A method for providing protection of a flexible rear window in a convertible vehicle with protective shields when the convertible top is in the top-down folded position comprising the steps of:
activating a top-down, roof closing mechanism of said convertible vehicle sufficient to allow placement of the protective shield panels,
positioning adjacent to one side of said flexible window, a first protective panel having generally rectangular shape with a first panel length dimension and a first panel width dimension that is less than said first panel length dimension, such that said first protective panel is slightly greater in perimeter dimensions than said convertible vehicle flexible rear window when placed over said window, said first protective panel further having a first protective panel thickness and
positioning adjacent to the opposite side of said flexible window, a second protective panel having generally rectangular shape with a second panel length dimension and a second panel width dimension that is less than said second panel length dimension, such that said second protective panel is slightly greater in perimeter dimensions than said convertible vehicle flexible rear window when said second protective panel is placed under said window, said second protective panel having a second protective panel thickness slightly greater than said first protective panel thickness, and
securing the top-down, roof closure mechanism to full closure with the first and second protective panels operatively placed,
wherein the first protective panel and second protective panel are positioned on either side of the flexible rear window and are held in place by compressive force of the folded convertible roof.
